(19) United States
(12) Patent Application Publication
(10) Pub. No.: US 2010/0290622 A1
(43) Pub. Date: Nov. 18, 2010

(54) WIRELESS COMMUNICATION SYSTEM AND METHOD FOR AUTOMATIC NODE AND KEY REVOCATION

(75) Inventors: Oscar Garcia Morchon, Aachen (DE); Bozena Erdmann, Aachen (DE); Martijn Maas, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/812,694

(22) PCT Filed: Jan. 16, 2009
(86) PCT No.: PCT/IB2009/050160

§ 371 Date: Jul. 13, 2010

Related U.S. Application Data
(60) Provisional application No. 61/022,057, filed on Jan. 18, 2008.
(60) Provisional application No. 61/083,828, filed on Jul. 25, 2008.

(51) Int. Cl. H04W 12/04

(52) U.S. Cl. 380/273

(57) ABSTRACT

A wireless system and method to control the cryptographic keying material that has been compromised in the network; exclude captured nodes from the network; and update compromised keying material in uncompromised devices are described. This system and method is useful in alpha-secure key distribution systems comprising a multitude of alpha-secure keying material shares to be controlled, revoked or updated.

### BACKGROUND AND SUMMARY

Wireless communication technology has significantly advanced making the wireless medium a viable alternative to wired solutions. As such, the use of wireless connectivity in data and voice communications continues to increase.

Wireless control networks (WCNs) used for lighting, heating, ventilation and air conditioning, safety/security aim at removing wires in buildings in order to make the control systems more flexible and to reduce costs of installation. WCNs might be composed of hundreds of wireless nodes, such as lighting or heating, ventilation and air conditioning (HVAC) devices, communicating in an ad hoc manner. WCNs face new security threats, like message injection, network-level intrusion and pose new security requirements, such as access control. Thus, the provision of basic security services, namely authentication, authorization, confidentiality and integrity to WCNs is fundamental. This requires a consistent and practical key distribution architecture (KDA) for WCNs allowing WCN nodes to establish a symmetric secret, so that further security services can be provided based on this secret. For instance, IEEE 802.15 and its progeny (commonly known as ZigBee) is an emerging WCN industry standard, and provides cryptographic mechanisms and simple key establishment methods, which requiring the participation of an online trust center (OTC). There are several drawbacks to these known mechanisms. These include resource overload around the OTC a single point of failure. Alternatively, alpha-secure distributed key distribution solutions have been proposed, including but not limited to: Deterministic Pairwise Key Pre-distribution Scheme [DPKPS], [HDPKPS], and [OHKPS]. α-Secure Key Establishment (αSKE) refers to a key distribution and establishment approach with the α-secure property. Namely, α entities must be compromised to crack the system. These schemes are known for group keying in traditional networks; and subsequently have been applied to wireless sensor networks.

In general, some root α-secure keying material (KM^{root}) stored by the trust center in a secure location is used to generate and distribute an α-secure keying material share (αSKM_{ID}) to each entity ID in the system. αSKM shares can be used for distributed key agreement afterwards. A trivial αSKE can be generated by using as α-secure KM^{root} a single symmetric bivariate polynomial f(x,y) of degree α over a finite field f_{q}, with a sufficiently large q to accommodate a cryptographic key. Each entity, ID, receives as αSKM_{ID} a polynomial share, f(ID,y), generated by evaluating the original symmetric bivariate polynomial in x=ID. Two entities, ID_A and ID_B, can agree on a pairwise key by evaluating their respective polynomial shares in the identity of the other party. In particular,

K_{ID}_{_{—}}_{A, ID}_{_{—}}_{B}=f(ID_{—}A,y)|_{y=ID}_{_{—}}_{B}=f(ID_{—}B,y)|_{y=ID}_{_{—}}_{A} (eq. 1)

Note that only entities carrying correlated αSKM can agree on a common secret. Thus, the two entities are referred to as belonging to the same security domain if both entities have correlated αSKM, i.e., generated from the same KM^{root}. A security domain (SD) can represent the whole WSN, the possession of a feature, or be determined by the location of entities in the WSN. Other alpha-secure schemes allow linking some information to the material used for key generation in order to provide advanced identification or access control capabilities.

However, known methods and protocols fail to provide node and key revocation methods. ZigBee wireless control and sensor networks are being used in multitude of scenarios such as lighting control or patient monitoring. Security and privacy is essential for wireless systems in order to comply with legal requirements such as HIPAA in USA. Key element to achieve strong security is the provision of a simple and consistent key distribution scheme (KDS). Recently, several key distribution approaches have been introduced to enable efficient key agreement between wireless sensor and actuator nodes. However, known methods lack a tool and method to revoke compromised nodes and keys in an efficient manner from the network. This is especially problematic in ZigBee where there is not a specific solution for this purpose.

For example, ZigBee provides only for link key overwriting and network key update. In the case of X-secure systems (e.g., based on polynomials), if a polynomial is compromised, the entire system could be compromised. For example, the polynomial should be updated, requiring sending bulky keying material (up to several kilobytes of data; depending on different parameters) to each and every node in the network that contains this polynomial in its keying material; but no means are provided to optimize that process.

What is needed therefore is a method and apparatus that overcomes at least the shortcoming of the known cryptographic techniques described above.

In accordance with representative embodiment, in a wireless communication network, a method of wireless communication includes controlling cryptographic keying material that has been compromised in the network; excluding captured nodes from the network; and updating compromised keying material in uncompromised devices.

In accordance with another representative embodiment, a wireless communications system comprises a wireless station comprising a key revocation tool (KRT). The system also comprises a plurality of wireless nodes, each comprising keying material. The KRT is operative to exclude a compromised node from the system, and to update keying material in uncompromised nodes.

### BRIEF DESCRIPTION OF THE DRAWINGS

The present teachings are best understood from the following detailed description when read with the accompanying drawing figures. It is emphasized that the various features are not necessarily drawn to scale. In fact, the dimensions may be arbitrarily increased or decreased for clarity of discussion.

FIG. 1 is a simplified schematic representation of a system in accordance with a representative embodiment.

FIG. 2 is a flow chart illustrating a revocation process on the KRT in accordance with a representative embodiment.

FIG. 3 is a conceptual view of the alpha-secure keying material in accordance with a representative embodiment wherein the DPKPS key distribution scheme is used.

### DETAILED DESCRIPTION

In the following detailed description, for purposes of explanation and not limitation, example embodiments disclosing specific details are set forth in order to provide a thorough understanding of the present teachings. However, it will be apparent to one having ordinary skill in the art having had the benefit of the present disclosure that other embodiments that depart from the specific details disclosed herein. Moreover, descriptions of well-known devices, methods, systems and protocols may be omitted so as to not obscure the description of the example embodiments. Nonetheless, such devices, methods, systems and protocols that are within the purview of one of ordinary skill in the art may be used in accordance with the example embodiments. Finally, wherever practical, like reference numerals refer to like features.

It is noted that in the illustrative embodiments described herein, the network may be a wireless network with a centralized architecture or a decentralized architecture. Illustratively, the network may be one which IEEE 802.15. Moreover, the network may be a cellular network; a wireless local area network (WLAN); a wireless personal area network (WPAN); or a wireless regional area network (WRAN). The embodiments are described in connection with a medium access control layer (MAC) and physical layer (PHY) of the fixed point-to-multipoint wireless regional area networks operating in the VHF/UHF TV broadcast bands between 54 MHz and 862 MHz. Again, it is emphasized that this is merely illustrative and that applications to other systems are contemplated.

Generally, and as described herein, a practical and efficient tool and method for revocation of node and cryptographic material in WCNs are described. The method illustratively includes a λ-secure polynomial-based cryptographic material, in which the impact on the network performance during the update is minimized. While the present description relates to WCNs, the methods and apparatuses are applicable to 802.15.4/ZigBee based networks, and in general to many secure wireless sensor networks applications.

In accordance with representative embodiment, a node and keying material revocation tool, Key Revocation Tool (KRT) are described. The KRT provides an interface to allow entering the identity of the to-be-revoked device. Additionally, the KRT is provided with the revocation reasons, e.g., revocation due to the compromise of its cryptographic material, expiration of the current cryptoperiod or replacement of some nodes in the network. The KRT has access to the cryptographic material assigned to/used by each particular WCN node in the network as it is located (or is part) of the trust center of the network, and thus, it is capable of changing it.

Depending on the revocation reasons, type of the keying material used and user-defined security policy, the KRT triggers the necessary revocation actions, taking care of minimum performance impact.

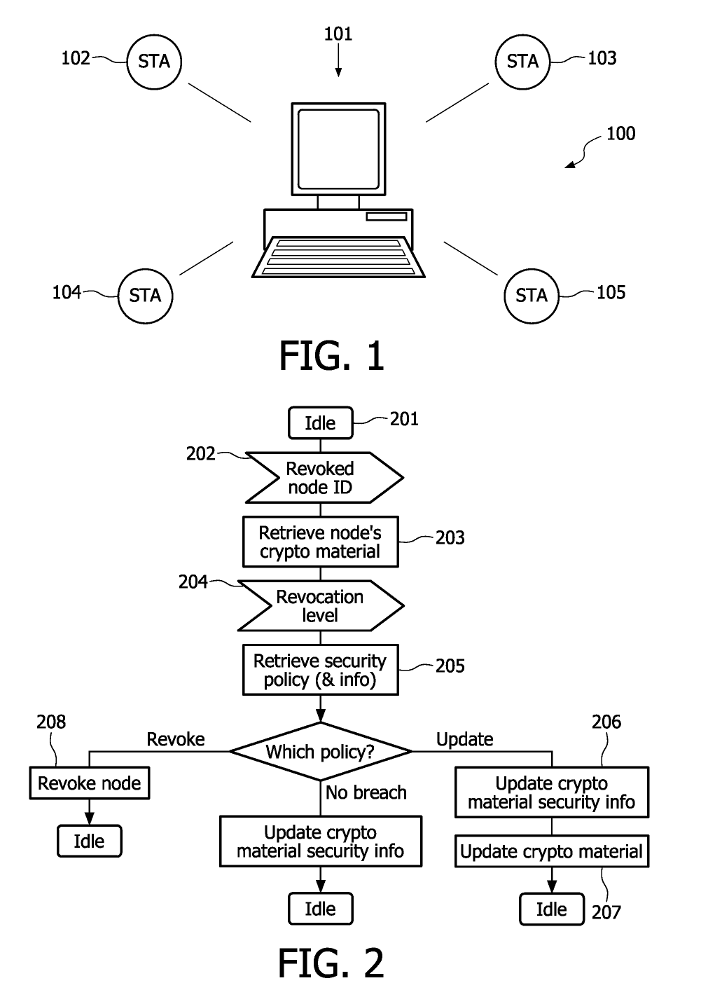

FIG. 1 is a simplified schematic diagram of a system 100 in accordance with a representative embodiment. The system 100 is illustratively comprises a centralized medium access control (MAC) layer. This facilitates the description of certain salient features of the present teachings. Notably, distributed MAC protocols are contemplated. As should be apparent to one of ordinary skill in the art having had the benefit of the present disclosure, if distributed network protocol included the KRT of the present disclosure, intrusion detection methods of the present teaching could include submission of the identity of the to-be-revoked node can be submitted by other WCN nodes.

The system 100 includes an access point (AP) 101, which is represented as a personal computer, although many other types of devices are contemplated for this function. The AP 101 is in communication with a plurality of wireless stations (STAs) 102-105 and includes the KRT.

The KRT is instantiated in software in the AP 101, for example. Alternatively, the KRT may be implemented as separate (HW) device, dedicated to the function of key revocation or can be (one of many) SW agent(s), running on a device responsible for network and/or network security management, such as a ZigBee Trust Centre (TC). Depending on the type of the cryptographic material in use, either the copy of the cryptographic material (e.g. the trust-center master key (TC-MK) or the network key in case of ZigBee) or the input data necessary for re-calculation/re-generation of the cryptographic material. For instance, in an alpha-secure key distribution system, the keying material root used to generate keying material shares for nodes should be stored (e.g., a bivariate polynomial function f(x,y) over a finite field F_{q} used to generate the keying material shares for node ID, f_{ID}(y)=f(ID,y)) may need to be stored on the KRT. The data can be stored locally on this AP, other separate device as indicated, external data storage or accessible over one of the communication interfaces.

The STAs 102-105 are commonly referred to herein as nodes, and comprise keying material (cryptographic keys or information used to generate cryptographic keys during operation), some of which are noted herein. The present teachings relate generally with maintaining system integrity; and particularly to key revocation if a node(s) become compromised. In certain embodiments, the nodes are revoked (i.e., no longer part of the system 100); and in other embodiments, the keying material is selectively updated to ensure that any compromised keying material is replaced. In yet other embodiments, some nodes are revoked and keying material of other nodes is updated.

Applications of the system include various disparate technical fields and applications. For example, the system 100 may be a lighting control system with a centralized AP 101 providing system integrity to individual lighting components and controls thereof. Notably, the lighting components or controls, or both, may be wireless stations. It is emphasized that the application to lighting control is merely illustrative, and that other applications are contemplated. Some additional examples of these applications include the use of wireless medical sensors for health monitoring purposes. Illustratively, users might carry a body sensor network comprising medical testing devices (e.g., ECG, Sp02 or thermometer) configured as wireless sensors. These sensors are used to monitor the user's health remotely at the hospital, at home, in the gym, etc. An additional application refers to the use of short range wireless technologies (e.g., 802.15.4/ZigBee) in telecom applications to locally broadcast information over 802.15.4/ZigBee to users. This information or the like might be displayed on user's mobile phones. Still another use scenario refers to control systems comprising several devices and cooperating for increased security and reliability.

FIG. 2 is a flow chart illustrating a revocation process with the KRT in accordance with a representative embodiment. At step 201, the system is idle. At step 202, an identification of the to-be-revoked node can be effected one of a variety of sources. For instance, the identification can be revoked by the user via a User Interface (UI) of the KRT, such as the AP 101, which includes intruder detection. The intruder detection algorithm usefully determines if a keying material of a node 102-105 has been corrupted. For example, if the keying material is a polynomial-based λ-secure keying material, the algorithm determines if a polynomial is corrupted by an intruder. It is useful to note that polynomial-based λ-secure keying material might comprise a high number of polynomial shares depending on the approach used. These include, but are not limited to polynomial shares used to generate a same key if key segmentation or identifier extensions techniques are used or used different security domains [HDPKPS]).

In a representative embodiment, the algorithm is instantiated in software in the AP 101. Moreover, it is emphasizes that other types of APs are contemplated, including but not limited to a commissioning tool; and that one of a variety of intruder detection algorithms for use in centralized or distributed networks are contemplated. Step 202 may include providing the node's identifier to the KRT. In a representative embodiment, the node's identifier may be a 16-bit network address; or an IEEE address in the case of a ZigBee device; or the node's cryptographic identifier in other systems. The step may also include providing a node's location. The location may be provided using a known graphical tool, such as clicking the icon of the selected device on a 3D floor plan; or may be provided via dedicated in-band interaction. Alternatively, the node's location can be identified by the KRT itself, such as via a periodic key update.

At step 203, the cryptographic material in use may be identified. The cryptographic material may include: asymmetric keys (public/private keys); symmetric keys; or polynomial-based λ-secure keying material. For example, the symmetric keys may comprise a hierarchy of pairwise keys, such as ZigBee Trust Centre Master Key (TC-MK), Trust Centre Link Keys (TC-LK) and/or Application Link Keys (ALK); or a group key used by more than two devices, such as a ZigBee NWK key. The polynomial based λ-secure keying material may be comprise a single flat security domain as in [DPKPS], a hierarchical structure of the security domains as in [HDPKPS], or a multidimensional structure of security domains [OHKPS] with a single or multiple polynomial shares constituting the cryptographic material for a particular security domain or for key generation.

It is noted that a WCN node (e.g., nodes 102-105) of representative embodiments may use several types of cryptographic material. For example, a ZigBee WCN node could use polynomial-based λ-secure keying material for establishment of symmetric keys in a distributed manner, subsequently used to secure communication over the ZigBee network.

At step 204 one of a variety of revocation levels is defined. The revocation level depends on, for example, the revocation cause and the user's intention with the revoked device. A revocation level (or threshold) indicating a security breach includes, but is not limited to: the situations in which node has been stolen or its communication link(s) are irreversibly compromised (so that removal of security material is necessary); and various types of successful cryptographic attacks (e.g. brute-force attack on a particular key). The revocation level, which does not indicate a security breach may be suitable for situations like node removal, node replacement or expiration of the current cryptoperiod. The revocation level may force cryptographic material update, either on explicit user request or done by KRT on time-basis. In the last case, the node is not removed from the network, but just provided with new cryptographic material. Depending on the keying material revocation or update reason the revocation level might be adapted to minimize the impact of revocation or update in the network performance as explained below.

The security policy, which is identified in step 205, is dependent, among other considerations, on the type of cryptographic material used. The policy can be defined by the system administrator, depending on the application needs. The policy may also define that the cryptographic material may need to be updated on other events, e.g. on node leaving or joining the network; periodicity and the like. Usually, security breach triggered revocation of a node requires: (i) removing the compromised keying material from other nodes, in case of symmetric cryptography; (ii) adding the compromised node to revocation list, in case of asymmetric cryptography or alpha-secure key distribution schemes; (iii) updating compromised keying material in the compromised node(s).

Some keying material has the property of being λ-secure, which means that only a coalition of at least λ+1 compromised nodes, compromises the system. For example, λ-secure keying material can be used by taking a symmetric bivariate polynomial and distributing polynomial shares to different sensor nodes. Thus, potentially, up to λ compromised nodes sharing a correlated polynomial share in their Keying Material could be tolerated. At step 206, the KRT keeps track of the number of security breaches happening to each particular fragment of polynomial share fᵢand/or security domain SDᵢ. In a representative embodiment, a policy-defined number rᵢ (by default, from the range {1, . . . , λ_{i }}) of security breaches can be tolerated per polynomial share fᵢ and/or in each SDᵢ. Some keying material has the property of being λ-secure, which means that only a coalition of at least λ+1 compromised nodes compromises the system. For example, λ-secure keying material can be used by taking a symmetric bivariate polynomial and distributing polynomial shares to different sensor nodes. Thus, potentially, up to λ compromised nodes sharing a correlated polynomial share in their Keying Material could be tolerated.

However, since any compromised node gives access to part of the system other different policies may be defined, for instance, by setting an acceptable limit of compromised nodes. Thus, at step 206 the KRT keeps track of the number of security breaches happening to each particular polynomial fᵢ and/or security domain SDᵢ. Observe that a SDi might comprise a multitude of polynomials. A policy-defined number rᵢ (by default, from the range {1, . . . , λ_{i}}) of security breaches can be tolerated per polynomial fᵢ and/or in each SDᵢ. Observe that the number of compromised polynomial shares rᵢ for polynomial fi(x,y) might be bigger than λᵢ depending on the attack model considered. If this SDi uses a multitude of polynomials the policy defines a vector R=[r₁, r₂, . . . , rₜₒₜₐₗ] where total is the number of polynomials in the security domain and rₖ counts the number of polynomial shares that have been broken in polynomial fₖ(x,y) of degree λₖ. The actions performed during the update of the cryptographic material, which are carried out in step 207, depend on the type of cryptographic material.

It is noted that the value for the threshold rk might take value higher than λₖ (presuming that not all the lost devices have been compromised) to improve the performance of the system and minimize the effect of keying material update. Alpha-secure key distribution schemes might incorporate different techniques to improve the system performance. In some techniques such as key segmentation or identifier extension, a key is calculated as the concatenation of several sub-keys, each of them generated from a different alpha-secure segment, e.g., a different alpha-secure polynomial. In those schemes the KRT can use different techniques to minimize the effect of key revocation on the network. For instance, if all the segments are to be updated, the KRT might update segment by segment instead of updating all the alpha-secure segments at the same time. This approach allows the KRT to recover a minimal security level faster without overloading the communication channel due to the keying material transmissions. This also minimizes the amount of memory reserved to store additional sets of keying material during the update phase. Other alpha-secure key distribution schemes might comprise independent alpha-secure security domains.

Illustratively, each alpha-secure security domain might be a different alpha-secure polynomial. In those schemes some alpha-secure security domains might be compromised and others not. In this situation the KRT only updates keying material of compromised alpha-secure security domains.

At step 208, the method continues where the actions performed during revocation of the security information on the cryptographic material depend on the type of cryptographic material.

In case of revocation of symmetric keys, the following actions should be taken: the master link key shared between the revoked device and the OTC, if any, shall be removed from the OTC; the application keys shared between the revoked node and other nodes in the network, if used, shall be removed from the nodes; and the group keys known to the revoked node, if any, should be updated.

In case of revocation of asymmetric keys, the following actions should be taken: the public key and/or certificate of the revoked node should be put on a revocation list.

In case of an update of symmetric keys, the revoked key, should be updated on all uncompromised devices, e.g. a new TC-MK should be configured into the to-be-updated WCN node and the OTC; whereas the group key must be updated on all group member devices. In case of update of asymmetric keys, the public key should be included in the revocation list; as known in the art. In case of update of asymmetric keys, the public key should be included in the revocation list; as known in the art.

In the update procedure of step 206, the new keying material may be stored in the nodes' memory. The new keying material may be either a complete set of Keying Material, a polynomial, or a single segment of a polynomial. The nodes do not switch to the new material until it receives a ‘key switch’ command from the TC. This way, the nodes stay in sync during the update process. Note that the smaller the size of the update material, the less memory is required in the node (i.e., updating the material segment by segment is more memory-efficient than polynomial by polynomial, which in turn is better than the complete set of Keying Material all at once).

In the case of updating/revoking the λ-secure polynomial-based keying material, compromised devices should be included in the revocation list while revoked polynomial shares in non-compromised nodes must be updated. The amount of to-be-updated cryptographic material depends on the construction of the keying material itself; providing room for optimization with respect to amount of bandwidth consumed by the update procedure.

Notably, if a single polynomial is used the entire keying material of all nodes needs to be updated; and if the cryptographic material is composed of independent polynomials, whether belonging to the same ([DPKPS]) or various security domains ([HDPKPS]),([OHKPS]), only the revoked polynomials or sub-polynomials have to be updated (and all derivative keys, if any, removed).

Despite the possibility of only partially updating the λ-secure polynomial-based keying material, the resulting amount of cryptographic data to be transmitted may still be too high for the network to handle. Thus, smart update strategies may be implemented by the KRT. The to-be-updated nodes could be grouped according to their functionalities and role. For example, the grouping could be according to application level communication (e.g. all nodes communicating on application level or linked via bindings build one group; e.g. a group of lamps and the switches and sensors controlling it build a group). Additionally, or alternatively, the grouping could be based on the importance of the application (e.g. lighting may be more important than HVAC); or their location (e.g. nodes in each room build a group). Then, the application keys are exchanged group by group, to minimize both the network load and the disruption in control traffic transmission.

As is known, to improve the computational efficiency, the key in polynomial-based methods is usually composed of t segments (e.g., t=8), each of which is computed by using sub-polynomials over smaller finite fields (e.g., F_{q′}, with q′=2¹⁶+1). In a representative embodiment, a polynomial can be updated segment by segment, thereby minimizing the size of the simultaneous update-messages and maximizing the availability of the nodes.

In one embodiment, where two devices node 102 and node 103 start communicating. Both nodes 102, 103 use to this end λ-secure keying material. However, this keying material was compromised, and thus, the network base station or trust center has started a keying material update procedure. In this situation, a node 102 has received a new set of λ-secure keying material, but node 103 have not. In this situation, a node must be able to store both old keying material and new keying material in order to allow interoperability. Moreover, when to nodes start communicating, both nodes exchange the version of the keying material they have. Also, if one node detects that the other node has a newer set of keying material, the node starts a keying material update with the trust center in order to get non-compromised λ-secure keying material and guarantee secure communications.

### EXAMPLE

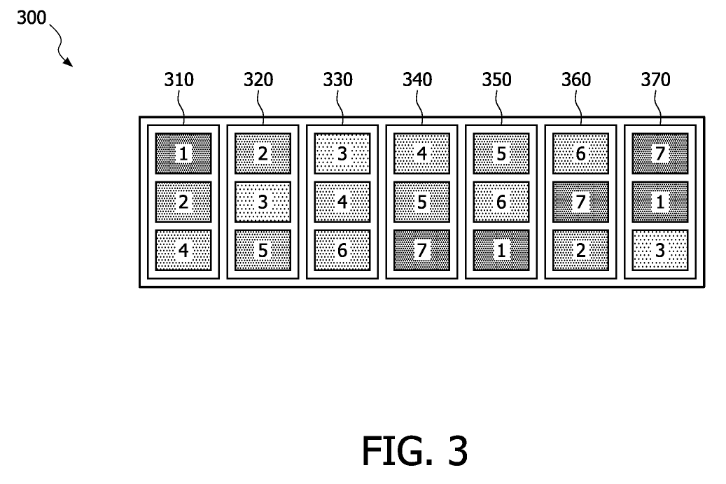

An example of the method of the present teachings is described in connection with FIG. 3. In the exampled, it is assumed the following DPKPS keying material (7 blocks of keying material over FPP (7,3,1)) distributed to a number of communication nodes (from left to right).

If, subsequently polynomial (1) would have been compromised, only polynomial (1) of nodes carrying keying material from the FPP blocks 1, 5 and 7 would have to be updated.

This reduces the number of to-be-updated nodes from 100% to approximately: (n+1)/(n²+n+1)*100% for [DPKPS] and the amount of new keying material to be distributed to each of the to-be-updated nodes to 1/(n+1)*100% [DPKPS] of the size of the total keying material.

The revocation of λ-secure polynomial-based keying material, as well as the update of the λ-secure polynomial-based keying material, requires the compromised keying material (part) to be updated on the involved nodes if more than rᵢ nodes are compromised in SDᵢ. Otherwise, non-compromised nodes in the network must not communicate with compromised nodes.

To this end, the KRT distributes (or updates) a revocation list stored on each sensor node. In this manner, non-compromised nodes will not communicate with captured nodes. Note that maintenance of local revocation table in the nodes is only necessary if the revoked nodes are not blocked by other means from contacting the non-compromised nodes. In ZigBee, revoked nodes can be kept out of the network by securely changing the network (if nwkSecureAllFrames=TRUE); since the revoked nodes would be prevented from re-joining the network by not knowing the current network key (which in high-security mode is not sent in the clear), the revoked nodes will be also unable to establish application layer communication or keys with the networked nodes. In this case, informing the non-revoked ZigBee nodes that the revoked node left the network allows the networked nodes to clean their tables (binding, neighbor, routing, address map, etc.); no revocation list needs to be kept.

For other types of wireless sensor networks other approaches could be used. On the one hand, a revocation list can be used to keep track on the revoked nodes and polynomial shares. On the other hand, the calculation of a link key between two nodes by means of λ-secure keying material can be also linked to the knowledge of the current network key. The network key is updated as soon as a node is detected to have been compromised. In this case, the calculation of a session link key between two nodes as ALK=h(AMK\NK) prevents compromised nodes from arbitrarily talking to other nodes, where: ALK refers to the session key used by two nodes to communicate, AMK refers to the key generated from λ-secure keying material, NK is the current network key, h( )is a one way hash function such as SHA-1 and | means concatenation.

In view of this disclosure it is noted that the various methods and devices described herein can be implemented in hardware and software. Among other benefits, the system and method of the present teachings allow for the efficient handling of alpha-secure key distribution systems while minimizing the network and node overload. Further, the various methods and parameters are included by way of example only and not in any limiting sense. In view of this disclosure, those skilled in the art can implement the present teachings in determining their own techniques and needed equipment to effect these techniques, while remaining within the scope of the appended claims.

1. In a wireless communication network, a method of wireless communication, comprising:
controlling cryptographic keying material that has been compromised in the network;
excluding captured nodes from the network; and
selectively updating compromised keying material in uncompromised devices based on a security policy.

2. The method of claim 1, wherein the updating the keying material further comprises replacing a piece of alpha-secure keying material that has been compromised.

3. The method of claim 1, wherein the piece of alpha- secure keying material comprises a polynomial that has been compromised.

4. The method of claim 2, wherein the keying material is alpha-secure keying material comprising several independent pieces of alpha-secure keying material.

5. The method claim 4, wherein the independent pieces of alpha-secure keying material are polynomials.

6. The method of claim 3, wherein the updating occurs in a sequential manner to minimize a network overload, or a node overload, or both.

7. The method of claim 1 further comprising: identifying a node to be revoked prior to the excluding.

8. The method of claim 7, further comprising: providing a key revocation tool (KRT) operative to revoke the identified node.

9. The method of claim 8, wherein the keying material is alpha-secure keying material and the KRT automatically handles the revocation parameters of the independent pieces of alpha-secure keying material given the identifier of the node to be revoked.

10. The method of claim 9, wherein the alpha-secure keying material comprises a single polynomial or polynomials.

11. The method of claim 1, further comprising, before the excluding, setting a revocation level that provides criteria of the excluding and the updating.

12. The method of claim 1, further comprising: tracking of a number of security breaches and measuring the number against a policy threshold.

13. A wireless communications system, comprising:
a wireless station comprising a key revocation tool (KRT); and
a plurality of wireless nodes, each comprising keying material, wherein the KRT is operative to exclude a compromised node from the system, and to selectively update keying material in uncompromised nodes based on a security policy.

14. A wireless communications systems as claimed in claim 13, wherein the KRT updates the keying material by replacing a piece or several pieces of alpha-secure keying material that has been compromised.

15. A wireless communications system as claimed in claim 13, wherein the KRT identifies a node to be revoked prior to excluding the node.

16. A wireless communications system as claimed in claim 13, wherein the nodes comprise lighting devices.

17. A wireless communications system as claimed in claim 13, wherein the nodes comprise medical devices used in a wireless sensor network.

18. A wireless communications system as claimed in claim 13, wherein the updated keying material further comprises a replacement piece of alpha-secure keying material.

19. A wireless communications system as claimed in claim 13, wherein the keying material is alpha-secure keying material and the KRT automatically handles the revocation parameters of the independent pieces of alpha-secure keying material given the identifier of the node to be revoked.

20. A wireless communications system as claimed in claim 18, wherein the piece of alpha-secure keying material is a polynomial.
